(19) United States
(12) Patent Application Publication
(10) Pub. No.: US 2013/0195176 A1
(43) Pub. Date: Aug. 1, 2013

(54) METHOD AND DEVICE FOR ENCODING/DECODING IMAGE USING ADAPTIVE ENCODING/DECODING MODE INDEXING METHOD

(71) Applicants: Jinhan Song, Seoul (KR); Jeongyeon Lim, Gyeonggi-do (KR); Yonggoo Kim, Seoul (KR); Yoonsik Choe, Gyeonggi-do (KR); Yungho Choi, Gyeonggi-do (KR); Sungjei Kim, Seoul (KR)

(72) Inventors: Jinhan Song, Seoul (KR); Jeongyeon Lim, Gyeonggi-do (KR); Yonggoo Kim, Seoul (KR); Yoonsik Choe, Gyeonggi-do (KR); Yungho Choi, Gyeonggi-do (KR); Sungjei Kim, Seoul (KR)

(73) Assignee: SK Telecom Co., Ltd., Seoul (KR)

(21) Appl. No.: 13/816,087

(22) PCT Filed: Aug. 9, 2011
(86) PCT No.: PCT/KR2011/005792

§ 371 Date: Apr. 15, 2013

(30) Foreign Application Priority Data
Aug. 10, 2010 (KR) 10-2010-0076790

(51) Int. Cl. H04N 7/26

(52) U.S. Cl. CPC H04N 19/00139
USPC 375/240.02

(57) ABSTRACT

A video encoding/decoding apparatus and method using adaptive encoding/decoding mode indexing are provided. A video encoding apparatus includes: a probability generation unit for calculating a probability of each encoding mode of blocks completely encoded before a current block; a bit assignment unit for assigning and indexing a bin string according to the probability of each encoding mode, which is calculated by the probability generation unit; and a video encoding unit for encoding an encoding mode of the current block, based on the bin string assigned by the bit assignment unit, when the current block is encoded.

### TECHNICAL FIELD

The present disclosure in one or more embodiments relates to an apparatus and a method for encoding/decoding images. More particularly, the present disclosure relates to a video encoding/decoding apparatus and method using adaptive encoding/decoding mode indexing, which are capable of improving data compression and encoding performances by calculating the probability of appearance of an encoding mode or decoding mode of a current block to be encoded or decoded and accordingly assigning a bin string or switching a preset sequence of encoding modes, and changing an indexing sequence of encoding modes or decoding modes or variable-length codes, adaptively to video characteristics to efficiently manage transmission bit.

### BACKGROUND

The statements in this section merely provide background information related to the present disclosure and may not constitute prior art.

A video compression apparatus based on H.264/AVC divides an input video into macroblocks and determines an encoding scheme suitable for each macroblock. Such a video compression apparatus performs encoding/decoding by using a preset coding mode indexing table in accordance with the suitable encoding scheme determined by an encoder.

However, since video content has various characteristics according to purposes and types, a coding mode having long bits is relatively more selected depending on the situation. Therefore, a mode indexing , which is of a fixed type and inadaptive to a video characteristic, may have many mode indexing bits assigned in a specific sequence or frame, entailing a limiting factor in the encoding performance. For example, in the case of a video containing a relatively small object and a complicated texture as compared with the video size, it is likely to select a P8×8 mode suitable for coding a complicated block in small unit rather than a P16×16 mode which is efficient to performing motion estimation in large unit. In this case, it is appropriate to undertake the mode indexing in a way to bring bits lower with P8×8 than with P16×16.

### DISCLOSURE

### Technical Problem

Therefore, the present disclosure has been made in an effort to effectively resolving a limiting factor of encoding performance, which occurs when a mode indexing is performed by using a fixed sequence or variable-length codes, and is directed to provide a video encoding/decoding apparatus and method using adaptive encoding/decoding mode indexing, which are capable of improving data compression and encoding performances by calculating the probability of appearance or simply probability of an encoding mode or decoding mode of a current block to be encoded or decoded and accordingly assigning a bin string or switching a preset sequence of encoding modes, and changing an indexing sequence of encoding modes or decoding modes or variable-length codes, adaptively to video characteristics to efficiently manage transmission bit.

### Summary

An aspect of the present disclosure provides a video encoding/decoding apparatus including: a video encoder for calculating a probability of each encoding mode of blocks completely encoded before a current block, assigning a bin string or switching a preset sequence of encoding modes according to the probability of each encoding mode, and accordingly encoding an encoding mode of the current block; and a video decoder for calculating a probability of each decoding mode of blocks completely decoded before a target block to be decoded, assigning a bin string or switching a preset sequence of decoding modes according to the probability of each decoding mode, and accordingly decoding an decoding mode of the target block, which is received from the video encoder.

Another aspect of the present disclosure provides a video encoding apparatus including: a probability generation unit for calculating a probability of each encoding mode of blocks completely encoded before a current block; a bit assignment unit for assigning and indexing a bin string according to the probability of each encoding mode, which is calculated by the probability generation unit; and a video encoding unit for encoding an encoding mode of the current block, based on the bin string assigned by the bit assignment unit, when the current block is encoded.

The video encoding apparatus may further include an exception processing unit for updating the bin string assigned by the bit assignment unit by transmitting additional bit of a video, a characteristic of which happens to change.

The probability generation unit may calculate probabilities of skip modes of the blocks completely encoded before the current block, and a probability of each division mode.

The probability generation unit may calculate the probability of each encoding mode of the blocks completely encoded before the current block in at least one unit of a frame, a sequence, and an encoding unit.

The bit assignment unit may assign the bin string, based on at least one of a Huffman code, an arithmetic code, and an exponential Golomb code.

Still another aspect of the present disclosure provides a video encoding apparatus including: a probability generation unit using encoding mode information obtained after completing an encoding of a macroblock, slice, frame or sequence of a video as a basis for calculating a probability of the encoding mode information; a bit assignment unit for assigning and indexing a bin string according to the probability of the encoding mode information, which is calculated by the probability generation unit; and a video encoding unit for encoding an encoding mode of the video, based on the bin string assigned by the bit assignment unit, when the macroblock, slice, frame or sequence of the video is encoded.

The probability generation unit may calculate the probability, based on encoding mode information included in at least one of a picture parameter set (PPS), a sequence parameter set (SPS), and a slice header (SH).

Yet another aspect of the present disclosure provides a video encoding apparatus including: a probability generation unit for calculating a probability of each encoding mode of blocks completely encoded before a current block; a coding sequence switching unit for switching and indexing a preset sequence of encoding modes according to the probability of each encoding mode, which is calculated by the probability generation unit; and a video encoding unit for video encoding unit for encoding an encoding mode of the current block, based on a sequence switched by the coding sequence switching unit, when the current block is encoded.

The video encoding apparatus may further include an exception processing unit for re-switching the sequence switched by the coding sequence switching unit according to a changing characteristic of a video.

The probability generation unit may calculate probabilities of skip modes of the blocks completely encoded before the current block, and a probability of each division mode.

The probability generation unit may calculate the probability of each encoding mode of the blocks completely encoded before the current block in at least one unit of a frame, a sequence, and an encoding unit.

Yet another aspect of the present disclosure provides a video encoding apparatus including: a probability generation unit for using encoding mode information obtained after completing an encoding of a macroblock, slice, frame or sequence of a video as a basis for calculating a probability of the encoding mode information; a coding sequence switching unit for switching and indexing a preset sequence of encoding modes according to the probability of the encoding mode information, which is calculated by the probability generation unit; and a video encoding unit for encoding an encoding mode of the video, based on the sequence switched by the coding sequence switching unit, when the macroblock, slice, frame or sequence of the video is encoded.

The probability generation unit may calculate the probability of appearance, based on encoding mode information included in at least one of a PPS, an SPS, and an SH.

Yet another aspect of the present disclosure provides a video decoding apparatus including: a probability generation unit for calculating a probability of each decoding mode of blocks completely decoded before a current block; a bit assignment unit for assigning and indexing a bin string according to the probability of each decoding mode, which is calculated by the probability generation unit; and a video decoding unit for decoding a decoding mode of the current block, based on the bin string assigned by the bit assignment unit, when the current block is decoded.

The video decoding apparatus may further include an exception processing unit for updating the bin string assigned by the bit assignment unit by transmitting additional bit of a video, a characteristic of which happens to change.

The probability generation unit may calculate probabilities of skip modes of the blocks completely decoded before the current block, and a probability of each division mode.

The probability generation unit may calculate the probability of each decoding mode of the blocks completely decoded before the current block in at least one unit of a frame, a sequence, and an encoding unit.

Yet another aspect of the present disclosure provides a video decoding apparatus including: a probability generation unit for using decoding mode information obtained after completing a decoding of a macroblock, slice, frame or sequence of a video as a basis for calculating a probability of the decoding mode information; a bit assignment unit for assigning and indexing a bin string according to the probability of the decoding mode information, which is calculated by the probability generation unit; and a video decoding unit for decoding a decoding mode of the macroblock, slice, frame or sequence of the video based on the bin string assigned by the bit assignment unit, when the macroblock, slice, frame or sequence of the video is decoded.

The bin string information used for decoding the decoding mode may be included in at least one of a PPS, an SPS, and an SH. In this case, the decoder may decode the decoding mode by directly using the bin string information transmitted while being included in at least one of the PPS, the SPS, and the SH, without assigning the bin string through the probability generation unit and the bit assignment unit.

Yet another aspect of the present disclosure provides a video decoding apparatus including: a probability generation unit for calculating a probability of each decoding mode of blocks completely decoded before a current block; a coding sequence switching unit for switching and indexing a preset sequence of decoding modes according to the probability of each decoding mode, which is calculated by the probability generation unit; and a video decoding unit for indexing and decoding a decoding mode, based on a sequence switched by the coding sequence switching unit, according to a decoding mode of the current block, when the current block is decoded.

The video decoding apparatus may further include an exception processing unit for re-switching the sequence switched by the coding sequence switching unit according to a changing characteristic of a video.

The probability generation unit may calculate probabilities of skip modes of the blocks completely decoded before the current block, and a probability of each division mode.

The probability generation unit may calculate the probability of each decoding mode of the blocks completely decoded before the current block in at least one unit of a frame, a sequence, and an encoding unit.

Yet another aspect of the present disclosure provides a video decoding apparatus including: a probability generation unit using decoding mode information obtained after completing a decoding of a macroblock, slice, frame or sequence of a video as a basis for calculating a probability of the decoding mode information; a coding sequence switching unit for switching and indexing a preset sequence of decoding modes according to the probability of the decoding mode information, which is calculated by the probability generation unit; and a video decoding unit for decoding a decoding mode of the video, based on a sequence switched by the coding sequence switching unit, when the macroblock, slice, frame or sequence of the video is decoded.

Yet another aspect of the present disclosure provides a video encoding/decoding method including: calculating a probability of each encoding mode of blocks completely encoded before a current block, assigning a bin string or switching a preset sequence of encoding modes according to the probability of each encoding mode, and accordingly encoding an encoding mode of the current block; and calculating a probability of each decoding mode of blocks completely decoded before a target block to be decoded, assigning a bin string or switching a preset sequence of decoding modes according to the probability of each decoding mode, and accordingly decoding an decoding mode of the target block, which is received from a video encoder.

Yet another aspect of the present disclosure provides a video encoding method including: calculating a probability of each encoding mode of blocks completely encoded before a current block; assigning and indexing a bin string according to the calculated probability of each encoding mode; and encoding an encoding mode of the current block, based on the assigned bin string, when the current block is encoded.

The video encoding method may further include updating the assigned bin string by transmitting additional bit of a video, a characteristic of which happens to change.

The process of calculating the probability may calculate probabilities of skip modes of the blocks completely encoded before the current block, and a probability of each division mode.

The process of calculating the probability may calculate the probability of each encoding mode of the blocks completely encoded before the current block in at least one unit of a frame, a sequence, and an encoding unit.

The process of assigning the bin string may assign the bin string, based on at least one of a Huffman code, an arithmetic code, and an exponential Golomb code.

Yet another aspect of the present disclosure provides a video encoding method including: using encoding mode information obtained after completing an encoding of a macroblock, slice, frame or sequence of a video as a basis for calculating a probability of the encoding mode information; assigning and indexing a bin string according to the calculated probability of each encoding mode information; and encoding an encoding mode of the video, based on the assigned bin string, when the macroblock, slice, frame or sequence of the video is encoded.

The process of calculating the probability may calculate the probability of appearance, based on encoding mode information included in at least one of a PPS, an SPS, and an SH.

Yet another aspect of the present disclosure provides a video encoding method including: calculating a probability of each encoding mode of blocks completely encoded before a current block; switching and indexing a preset sequence of encoding modes according to the calculated probability of each encoding mode; and encoding an encoding mode of the current block, based on the sequence switched in a sequence switching process, when the current block is encoded.

The video encoding method may further include re-switching the sequence switched by the sequence switching process, according to a changing characteristic of a video.

The process of calculating the probability may calculate probabilities of skip modes of the blocks completely encoded before the current block, and a probability of each division mode.

The process of calculating the probability may calculate the probability of each encoding mode of the blocks completely encoded before the current block in at least one unit of a frame, a sequence, and an encoding unit.

Yet another aspect of the present disclosure provides a video encoding method including: using encoding mode information obtained after completing an encoding of a macroblock, slice, frame or sequence of a video as a basis for calculating a probability of the encoding mode information; switching and indexing a preset sequence of encoding modes according to the calculated probability of the encoding mode information; and encoding an encoding mode of the video, based on the switched sequence, when the macroblock, slice, frame or sequence of the video is encoded.

Yet another aspect of the present disclosure provides a video decoding method including: calculating a probability of each decoding mode of blocks completely decoded before a current block; assigning and indexing a bin string according to the calculated probability of each decoding mode; and decoding a decoding mode of the current block, based on the assigned bin string, when the current block is decoded.

The video decoding method may further include updating the assigned bin string by transmitting additional bit of a video, a characteristic of which happens to change.

The process of calculating the probability may calculate a probability of a skip mode of the blocks completely decoded before the current block, and a probability of each division mode.

The process of calculating the probability may calculate the probability of each decoding mode of the blocks completely decoded before the current block in at least one unit of a frame, a sequence, and an encoding unit.

Yet another aspect of the present disclosure provides a video decoding method including: using decoding mode information obtained after completing a decoding of a macroblock, slice, frame or sequence of a video as a basis for calculating a probability of the decoding mode information; assigning and indexing a bin string according to the calculated probability of each decoding mode information; and decoding a decoding mode of the macroblock, slice, frame or sequence of the video based on the assigned bin string, when the macroblock, slice, frame or sequence of the video is decoded.

The bin string information used for decoding the decoding mode may be included in at least one of a PPS, an SPS, and an SH. In this case, the decoder may decode the decoding mode by directly using the bin string and indexing information transmitted while being included in at least one of the PPS, the SPS, and the SH, without undergoing the process of calculating the probability and the process of assigning and indexing the bin string according to the calculated probability of the decoding mode information.

Yet another aspect of the present disclosure provides a video decoding method including: calculating a probability of each decoding mode of blocks completely decoded before a current block; switching and indexing a preset sequence of decoding modes according to the calculated probability of each decoding mode; and decoding a decoding mode of the current block, based on the sequence switched by a sequence switching process, when the current block is decoded.

The video decoding method may further include re-switching the sequence switched by the sequence switching process, according to a changing characteristic of a video.

The process of calculating the probability may calculate probabilities of skip modes of the blocks completely decoded before the current block, and a probability of each division mode.

The process of calculating the probability may calculate the probability of each decoding mode of the blocks completely decoded before the current block in at least one unit of a frame, a sequence, and an encoding unit.

Yet another aspect of the present disclosure provides a video decoding method including: using decoding mode information obtained after completing a decoding of a macroblock, slice, frame or sequence of a video as a basis for calculating a probability of the decoding mode information; switching and indexing a preset sequence of decoding modes according to the calculated probability of each decoding mode information; and decoding a decoding mode of the video, based on the switched sequence, when the macroblock, slice, frame or sequence of the video is decoded.

### Advantageous Effects

According to the present disclosure as described above, it is possible to improve data compression and encoding performances by calculating the probability of an encoding mode or decoding mode of a current block to be encoded or decoded and accordingly assigning a bin string or switching a preset sequence of encoding modes, and changing an indexing sequence of encoding modes or decoding modes or variable-length codes, adaptively to video characteristics to efficiently manage transmission bit.

### DESCRIPTION OF DRAWINGS

FIG. 1 is a diagram schematically showing a video encoding apparatus according to one or more embodiments of the present disclosure;

FIG. 2 is diagram showing an example of probability information of an encoding mode by the video encoding apparatus of FIG. 1;

FIG. 3 is diagram showing an example of probability information of an encoding mode updated by the video encoding apparatus of FIG. 1;

FIG. 4 is a diagram schematically showing a video decoding apparatus according to one or more embodiments of the present disclosure;

FIG. 5 is a diagram schematically showing a video encoding apparatus according to another embodiment of the present disclosure;

FIG. 6 is diagram showing an example of a sequence of encoding modes switched by the video encoding apparatus of FIG. 5;

FIG. 7 is a diagram schematically showing a video decoding apparatus according to another embodiment of the present disclosure;

FIG. 8 is a flow diagram showing a video encoding method according to one or more embodiments of the present disclosure;

FIG. 9 is a flow diagram showing a video decoding method corresponding to the video encoding method of FIG. 8;

FIG. 10 is a flow diagram showing a video encoding method according to another embodiment of the present disclosure; and

FIG. 11 is a flow diagram showing a video decoding method corresponding to the video encoding method of FIG. 10.

### [DETAILED DESCRIPTION]

Hereinafter, embodiments of the present disclosure will be described in detail with reference to the accompanying drawings. In the following description, like reference numerals designate like elements although they are shown in different drawings. Further, in the following description of the present embodiments, a detailed description of known functions and configurations incorporated herein will be omitted for the purpose of clarity.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

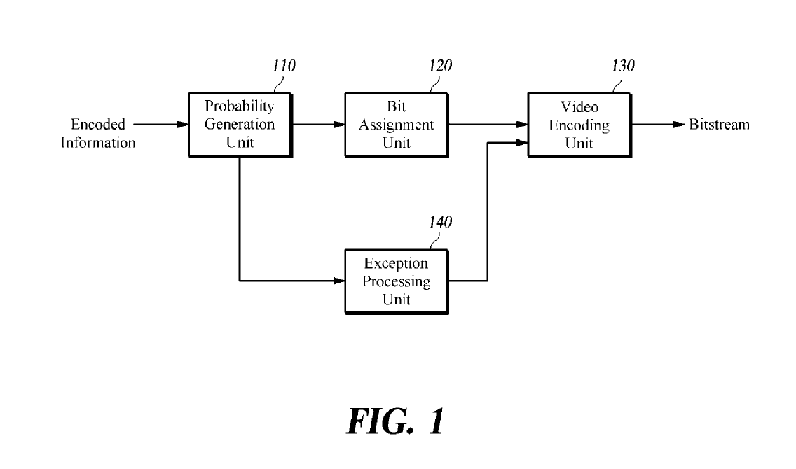

FIG. 1 is a diagram schematically showing a video encoding apparatus according to one or more embodiments of the present disclosure.

Referring to FIG. 1, the video encoding apparatus according to one or more embodiments of the present invention may include a probability generation unit 110, a bit assignment unit 120, a video encoding unit 130, and an exception processing unit 140.

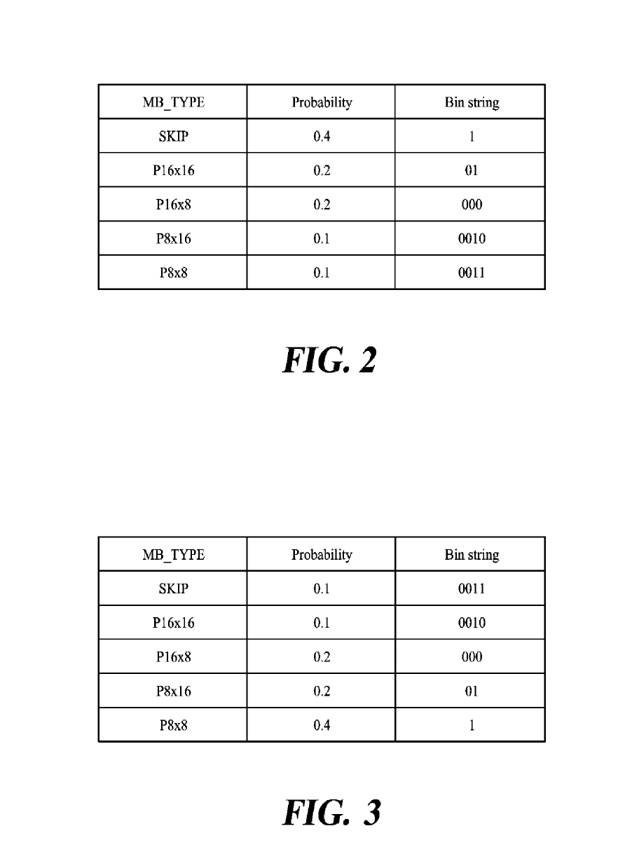

The probability generation unit 110 calculates the probability of each encoding mode of blocks completely encoded before a current block. That is, the probability generation unit 110 calculates entropy for each encoding mode, based on the probability of each encoding mode of the blocks completely encoded before the current block to be encoded. The encoding mode of the block may include the probability of information representing that the corresponding block is a skip mode, the probability of each partition or division mode of the corresponding block (for example, division modes of blocks of 16×8, 8×16, 8×8, 8×4, 4×8, and 4×4 within 16×16 block), and the like. In this case, the probability generation unit 110 may calculate the probability of each encoding mode of the blocks completely encoded before the current block in at least one unit of a frame, a sequence, and an encoding unit. For example, as shown in FIG. 2, in units of macroblocks and with respect to the corresponding macroblock's encoding modes of a skip mode, 16×16 division mode, 16×8 division mode, 8×16 division mode and 8×8 division mode, the probability generation unit 110 may calculate and tabulate the probability of the skip mode, probability of the 16×16 division mode, probability of the 16×8 division mode, probability of the 8×16 division mode and probability of the 8×8 division mode. The probability generation unit 110 may calculate probability, based on encoding mode information obtained after completing the encoding of a macroblock, slice, frame or sequence of a video, instead of the calculating of the probability of each encoding mode of the blocks completely encoded before the current block. In this case, the probability generation unit 110 may calculate the probabilities of the macroblock, slice, frame or sequence after the video encoding process, based on bin string information included in at least one of a picture parameter set (PPS), sequence parameter set (SPS), and slice header (SH). The PPS is header information for representing the encoding mode of the entire picture and may include information such as an entropy encoding mode, a picture-unit quantization parameter initial value, and the like. In addition, the SPS represents header information including overall information of the encoding of the entire sequence, such as a profile, a level, and the like, and the SH represents header information including overall information of the encoding of the slice. That is, the probability generation unit 110 may calculate the probabilities of the macroblock, slice, frame, or sequence of the video, based on the header information.

As shown in FIG. 2, the bit assignment unit 120 assigns and indexes the bin string according to the probability of each encoding mode calculated by the probability generation unit 110. The bin string means a bitstream represented by a set of binary numbers. The bit assignment unit 120 assigns the bin string, based on at least one of a Huffman code, arithmetic code and exponential Golomb code, and the assigned bin string is transmitted to a video decoding apparatus through a bitstream channel. When encoding the macroblock, slice, frame or sequence of the video, the bin string information assigned by the bit assignment unit 120 may be carried within at least one of the PPS, the SPS, and the SH to the video decoding apparatus.

When encoding the current block, the video encoding unit 130 encodes the encoding mode of the current block, based on the bin string assigned by the bit assignment unit 120. For example, if the encoding mode of the current block is the skip mode, it may be encoded as the current block encoding mode based on the bin string corresponding to the skip mode assigned by the bit assignment unit 120.

The exception processing unit 140 may be made to update encoding mode indexing information by transmitting additional information, instead of the probability information calculated by the probability generation unit 110. For example, in the case where the video is encoded by using the probability information of the encoding mode, as shown in FIG. 2, when the encoding mode indexing needs to be rapidly changed due to an abrupt scene change or a video characteristic change, the exception processing unit 140 may update the bin strings assigned by the bit assignment unit 120, as shown in FIG. 3, by transmitting additional bits of the changing video. Although FIG. 3 illustrates that the exception processing unit 140 updates and assigns the bin strings with reversed order of the probabilities calculated by the probability generation unit 110, the updating by the exception processing unit 140 is not limited to the illustration and the bin strings may be updated by various methods.

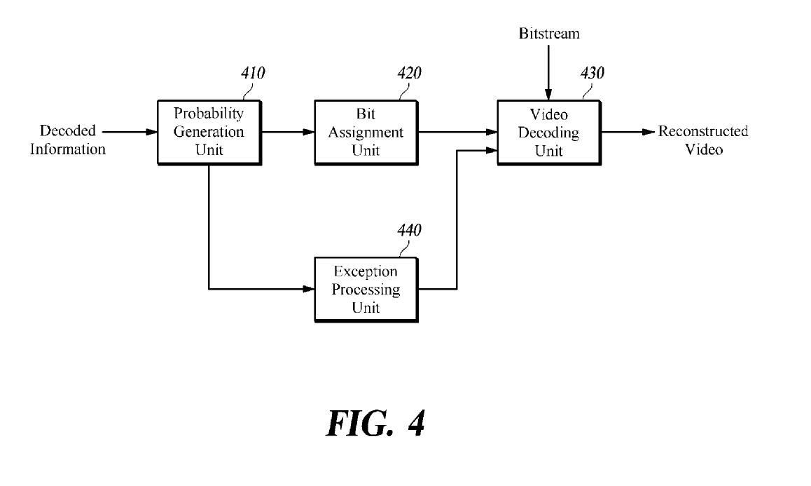

FIG. 4 is a diagram schematically showing a video decoding apparatus according to one or more embodiments of the present disclosure.

Referring to FIG. 4, a video decoding apparatus according to one or more embodiments of the present invention may include a probability generation unit 410, a bit assignment unit 420, a video decoding unit 430, and an exception processing unit 440.

The probability generation unit 410 calculates the probability of each decoding mode of blocks completely decoded before a current block. That is, the probability generation unit 410 calculates entropy for each decoding mode, based on the probability of each decoding mode of the blocks completely decoded before the current block to be decoded. As in the encoding mode, the decoding mode of the block may include the probability of information representing that the corresponding block is a skip mode, the probability of each division mode of the corresponding block, and the like. In this case, the probability generation unit 410 may calculate the probability of each decoding mode of the blocks completely decoded before the current block in at least one unit of a frame, a sequence, and an encoding unit. For example, as described with the probability generation unit 110 of FIG. 1, in units of macroblocks and with respect to the corresponding macroblock's decoding modes of a skip mode, 16×16 division mode, 16×8 division mode, 8×16 division mode and 8×8 division mode, the probability generation unit 410 may calculate and tabulate the probability of the skip mode, probability of the 16×16 division mode, probability of the 16×8 division mode, probability of the 8×16 division mode and probability of the 8×8 division mode.

The bit assignment unit 420 assigns and indexes the bin string according to the probability of each decoding mode calculated by the probability generation unit 410. The bit assignment unit 120 assigns the bin string, based on at least one of a Huffman code, an arithmetic code, and an exponential Golomb code.

When decoding the current block, the video decoding unit 430 decodes the decoding mode of the current block, based on the bin string assigned by the bit assignment unit 420. That is, the video decoding unit 430 decodes the decoding mode corresponding to the bin string assigned by the bit assignment unit 420, based on bitstream information received through a bitstream. For example, when the bin string corresponding to the skip mode is received through the bitstream, the bin string assigned by the bit assignment unit 420 and the decoding mode corresponding to the bin string received according to the decoding mode may be reconstructed. Instead of the probability generation unit 410 calculating the probability of each decoding mode of the blocks completely decoded before the current block and the bit assignment unit 420 assigning the bin string according to the probability, the video decoding unit 430 may decode the decoding mode by directly using the bin string information carried within at least one of a PPS, SPS and SH of a macro block, slice, frame or sequence encoded by an encoder.

The exception processing unit 440 may be made to update decoding mode indexing information by transmitting additional information, instead of the probability information calculated by the probability generation unit 410. For example, in the case where the video is decoded by using the probability information of the decoding mode, as shown in FIG. 2, when the decoding mode indexing needs to be rapidly changed due to an abrupt scene change or a video characteristic change, the exception processing unit 440 may update the bin strings assigned by the bit assignment unit 420, as shown in FIG. 3, by transmitting additional bits of the changing video.

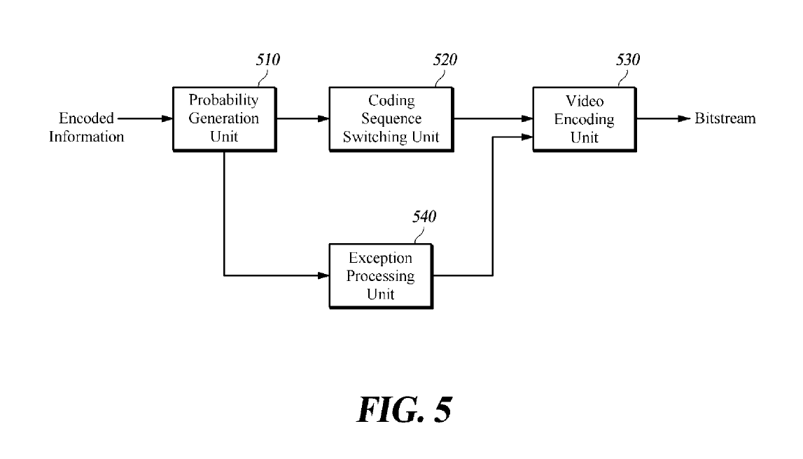

FIG. 5 is a diagram schematically showing a video encoding apparatus according to another embodiment of the present disclosure.

Referring to FIG. 5, the video encoding apparatus according to another embodiment of the present invention may include a probability generation unit 510, a coding sequence switching unit 520, a video encoding unit 530, and an exception processing unit 540.

The probability generation unit 510 calculates the probability of each encoding mode of blocks completely encoded before a current block. That is, the probability generation unit 510 calculates entropy for each encoding mode, based on the probability of each encoding mode of the blocks completely encoded before the current block to be encoded. The encoding mode of the block may include the probability of information for representing that the corresponding block is a skip mode, the probability of each division mode of the corresponding block, and the like. In this case, the probability generation unit 510 may calculate the probability of each encoding mode of the blocks completely encoded before the current block in at least one unit of a frame, sequence, and encoding unit. The probability generation unit 510 may calculate the probability, based on encoding mode information obtained after completing the encoding of a macroblock, slice, frame or sequence of a video, instead of calculating the probability of each encoding mode of the blocks completely encoded before the current block. In this case, the probability generation unit 510 may calculate the probabilities of the macroblock, slice, frame or sequence after the video encoding process, based on bin string information included in at least one of a PPS, SPS and SH.

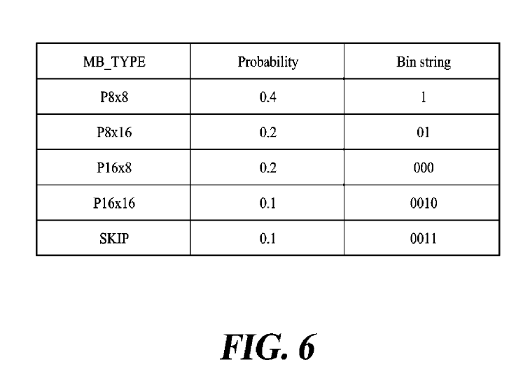

The coding sequence switching unit 520 switches and indexes the sequence of encoding modes according to the probability of encoding modes calculated by the probability generation unit 510. That is, unlike the case of assigning the bits for indexing the encoding mode as described above with reference to FIG. 1, the indexing may be performed by switching only the sequence of the encoding modes, without changing the preset and assigned bits of the encoding modes. For example, with respect to the fixed and assigned bits as shown in FIG. 2, the indexing may be performed by switching only the sequence of the encoding modes as shown in FIG. 6. The encoding mode information switched by the coding sequence switching unit 520 may be carried within at least one of the PPS, SPS and SH to the video decoder.

When encoding the current block, the video encoding unit 530 encodes the encoding mode of the current block, based on the sequence switched and indexed by the coding sequence switching unit 520.

When the video characteristic changes, the exception processing unit 540 re-switches the sequence switched by the coding sequence switching unit 520 according to the changing video characteristic. That is, in the case of encoding the video, when the encoding mode indexing needs to be rapidly changed due to an abrupt scene change or a video characteristic change, the exception processing unit 540 may perform indexing by re-switching the sequence of the encoding modes switched and indexed by the coding sequence switching unit 520.

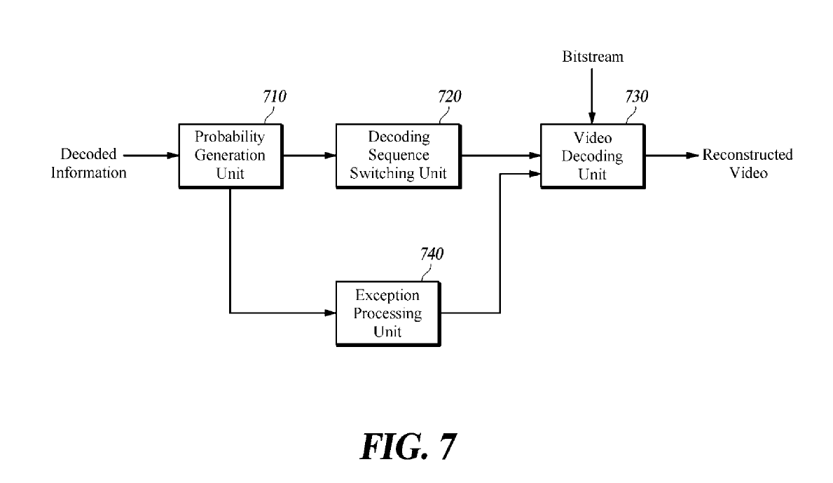

FIG. 7 is a diagram schematically showing a video decoding apparatus according to another embodiment of the present disclosure.

Referring to FIG. 7, the video decoding apparatus according to another embodiment of the present invention may include a probability generation unit 710, a decoding sequence switching unit 720, a video decoding unit 730 and an exception processing unit 740.

The probability generation unit 710 calculates the probability of each decoding mode of blocks completely decoded before a current block. That is, the probability generation unit 710 calculates entropy for each decoding mode, based on the probability of each decoding mode of the blocks completely decoded before the current block to be decoded. The decoding mode of the block may include the probability of information representing that the corresponding block is a skip mode, the probability of each division mode of the corresponding block, and the like. In this case, the probability generation unit 710 may calculate the probability of each decoding mode of the blocks completely decoded before the current block in at least one unit of a frame, sequence and encoding unit.

The decoding sequence switching unit 720 switches and indexes the sequence of decoding modes according to the probability of decoding modes calculated by the probability generation unit 710. That is, unlike the case of assigning the bits for indexing the decoding mode, the indexing may be performed by switching only the sequence of the decoding modes, without changing the preset and assigned bits of the decoding modes.

When decoding the current block, the video decoding unit 730 decodes the decoding mode of the current block, based on the sequence switched and indexed by the decoding sequence switching unit 720. Instead of the probability generation unit 710 calculating the probability of each decoding mode of the blocks completely decoded before the current block and the decoding sequence switching unit 720 switching the sequence of the decoding modes according to the probability, the video decoding unit 730 may decode the decoding mode by directly using the bin string information carried within at least one of a PPS, SPS and SH of a macro block, slice, frame or sequence encoded by an encoder.

When the video characteristic changes, the exception processing unit 740 re-switches the sequence switched by the decoding sequence switching unit 720 according to the changing video characteristic. That is, in the case of decoding the video, when the decoding mode indexing needs to be rapidly changed due to an abrupt scene change or a video characteristic change, the exception processing unit 740 may perform indexing by re-switching the sequence of the decoding modes switched and indexed by the decoding sequence switching unit 720.

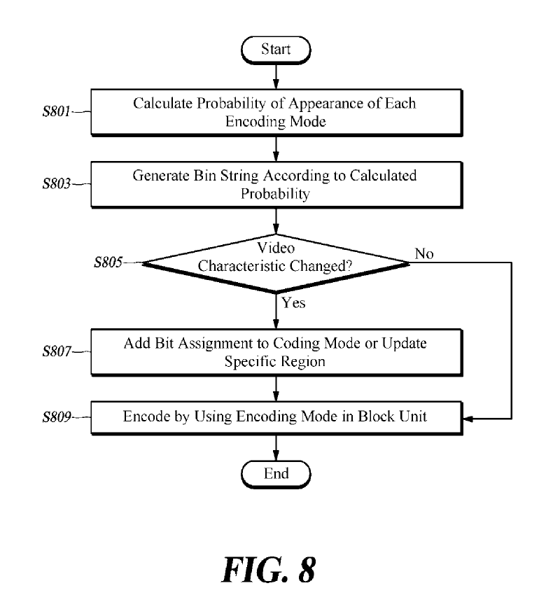

FIG. 8 is a flow diagram showing a video encoding method according to one or more embodiments of the present disclosure. Referring to FIGS. 1 and 8, the probability generation unit 110 calculates the probability of each encoding mode of blocks completely encoded before a current block in step S801. The encoding mode of the block may include the probability of information for representing that the corresponding block is a skip mode, the probability of each division mode of the corresponding block, and the like. In this case, the probability generation unit 110 may calculate the probability of each encoding mode of the blocks completely encoded before the current block in at least one unit of a frame, sequence and encoding unit. The probability generation unit 110 may calculate the probability, based on encoding mode information obtained after completing the encoding of a macroblock, slice, frame or a sequence of a video, instead of calculating the probability of each encoding mode of the blocks completely encoded before the current block. In this case, the probability generation unit 110 may calculate the probabilities of the macroblock, slice, frame or sequence after the video encoding process, based on bin string information included in at least one of a PPS, SPS and SH.

As shown in FIG. 2, the bit assignment unit 120 assigns and indexes the bin string according to the probability of each encoding mode calculated by the probability generation unit 110. The bit assignment unit 120 assigns the bin string, based on at least one of a Huffman code, arithmetic code and exponential Golomb code, and the assigned bin strings are transmitted to a video decoding apparatus through a bitstream channel. When encoding the macroblock, slice, frame or sequence of the video, the bin string information assigned by the bit assignment unit 120 may be carried within at least one of the PPS, SPS and SH to the video decoding apparatus.

When the encoding mode indexing needs to be rapidly changed due to an abrupt scene change or a video characteristic change (S805), the exception processing unit 140 may update the bin strings assigned by the bit assignment unit 120 by transmitting additional bits of the changing video or by changing bits of a specific region (S807).

When encoding the current block, the video encoding unit 130 encodes the encoding mode of the current block, based on the bin string assigned by the bit assignment unit 120 or the bin string updated by the exception processing unit 140 (S809).

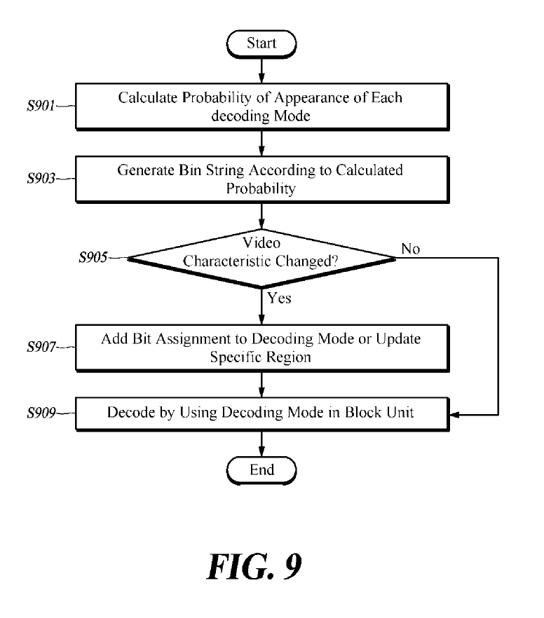

FIG. 9 is a flow diagram showing a video decoding method corresponding to the video encoding method of FIG. 8.

Referring to FIGS. 4 and 9, the probability generation unit 410 calculates the probability of each decoding mode of blocks completely decoded before a current block (S901). That is, the probability generation unit 410 calculates entropy for each decoding mode, based on the probability of each decoding mode of the blocks completely decoded before the current block to be decoded. As in the encoding mode, the decoding mode of the block may include the probability of information for representing that the corresponding block is a skip mode, the probability of each division mode of the corresponding block, and the like. In this case, the probability generation unit 410 may calculate the probability of each decoding mode of the blocks completely decoded before the current block in at least one unit of a frame, sequence and encoding unit.

The bit assignment unit 420 assigns and indexes the bin string according to the probability of each decoding mode calculated by the probability generation unit 410 (S903). The bit assignment unit 120 assigns the bin string, based on at least one of a Huffman code, arithmetic code and exponential Golomb code.

When decoding the video by using the probability information of the decoding mode, if the decoding mode indexing needs to be rapidly changed due to an abrupt scene change or a video characteristic change (S905), the exception processing unit 440 may update bin strings assigned by the bit assignment unit 420 by transmitting additional bits of the changing video or by updating a bin string of a specific region (S907).

When decoding the current block, the video decoding unit 430 decodes the decoding mode of the current block, based on the bin string assigned by the bit assignment unit 420 (S909). That is, the video decoding unit 430 decodes the decoding mode corresponding to the bin string assigned by the bit assignment unit 420, based on bitstream information received through a bitstream. Instead of the probability generation unit 410 calculating the probability of each decoding mode of the blocks completely decoded before the current block and the bit assignment unit 420 assigning the bin string according to the probability, the video decoding unit 430 may decode the decoding mode by directly using the bin string information carried within at least one among a PPS, SPS and SH of a macro block, slice, frame or sequence encoded by an encoder.

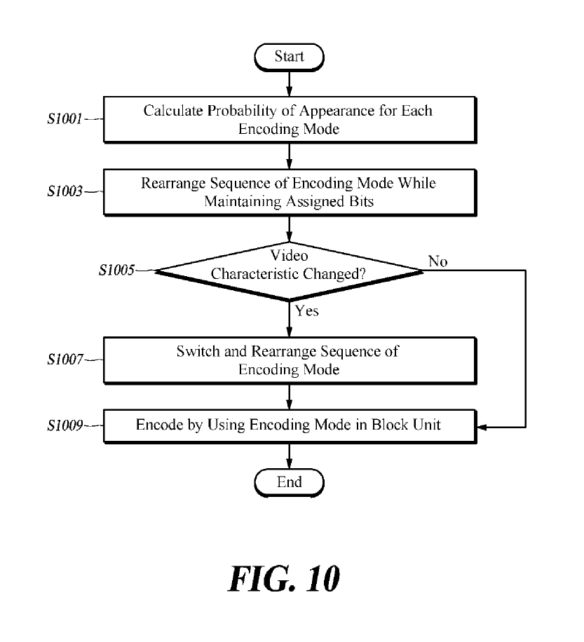

FIG. 10 is a flow diagram showing a video encoding method according to another embodiment of the present disclosure.

Referring to FIGS. 5 and 10, the probability generation unit 510 calculates the probability of each encoding mode of blocks completely encoded before a current block (S1001). That is, the probability generation unit 510 calculates entropy for each encoding mode, based on the probability of each encoding mode of the blocks completely encoded before the current block to be encoded. In this case, the probability generation unit 510 may calculate the probability of each encoding mode of the blocks completely encoded before the current block in at least one unit of a frame, sequence and encoding unit. The probability generation unit 510 may calculate the probability, based on encoding mode information obtained after completing the encoding of a macroblock, slice, frame or sequence of a video, instead of calculating the probability of each encoding mode of the blocks completely encoded before the current block. In this case, the probability generation unit 510 may calculate the probabilities of the macroblock, slice, frame or sequence after the video encoding process, based on bin string information included in at least one of a PPS, SPS, and SH.

The coding sequence switching unit 520 switches, rearranges, and indexes the sequence of encoding modes according to the probability of encoding modes calculated by the probability generation unit 510 (S1003). That is, the coding sequence switching unit 520 may rearrange and index the encoding modes by switching only the sequence of the encoding modes, without changing the preset and assigned bits of the encoding mode. The encoding mode information switched by the coding sequence switching unit 520 may be carried within at least one of the PPS, SPS and SH to the video decoder.

When the video characteristic changes (S1005), the exception processing unit 540 re-switches the sequence switched by the coding sequence switching unit 520 according to the changing video characteristic (S1007). That is, in the case of encoding the video, when the encoding mode indexing needs to be rapidly changed due to an abrupt scene change or a video characteristic change, the exception processing unit 540 may perform indexing by re-switching the sequence of the encoding modes switched and indexed by the coding sequence switching unit 520.

When encoding the current block, the video encoding unit 530 encodes the encoding mode of the current block, based on the sequence switched and indexed by the coding sequence switching unit 520 (S1009).

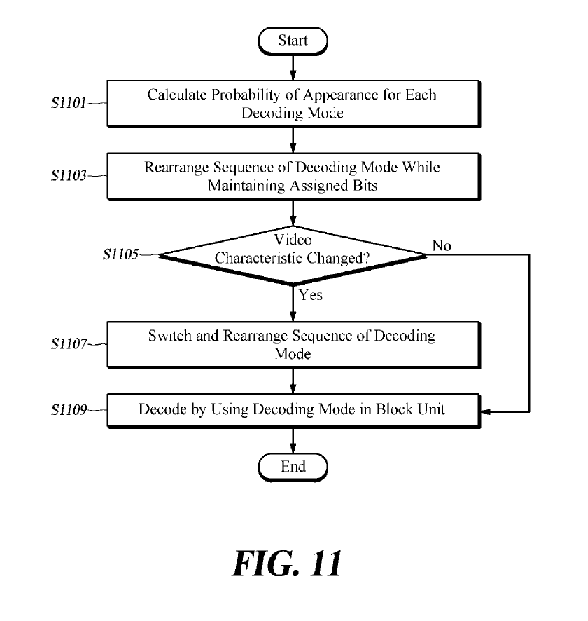

FIG. 11 is a flow diagram showing a video decoding method corresponding to the video encoding method of FIG. 10.

Referring to FIGS. 7 and 11, the probability generation unit 710 calculates the probability of each decoding mode of blocks completely decoded before a current block (S1101). That is, the probability generation unit 710 calculates entropy for each decoding mode, based on the probability of each decoding mode of the blocks completely decoded before the current block to be decoded. In this case, the probability generation unit 710 may calculate the probability of each decoding mode of the blocks completely decoded before the current block in at least one unit of a frame, sequence and encoding unit.

The decoding sequence switching unit 720 switches and indexes the sequence of decoding modes according to the probability of decoding modes calculated by the probability generation unit 710 (S1103). That is, unlike the case of assigning the bits for indexing the decoding mode, the indexing may be performed by switching only the sequence of the decoding modes, without changing the preset and assigned bits of the decoding modes.

When the video characteristic is changed (S1105), the sequence switched by the decoding sequence switching unit 720 is re-switched according to the changing video characteristic (S1107). That is, in the case of decoding the video, when the decoding mode indexing needs to be rapidly changed due to an abrupt scene change or a video characteristic change, the exception processing unit 740 may perform indexing by re-switching the sequence of the decoding modes switched and indexed by the decoding sequence switching unit 720.

When decoding the current block, the video decoding unit 730 decodes the decoding mode of the current block, based on the sequence switched and indexed by the decoding sequence switching unit 720 (S1109). Instead of the probability generation unit 710 calculating the probability of each decoding mode of the blocks completely decoded before the current block and the decoding sequence switching unit 720 switching the sequence of the decoding modes according to the probability, the video decoding unit 730 may decode the decoding mode by directly using the bin string information transmitted while being included in at least one of a PPS, SPS and SH of a macro block, slice, frame or sequence encoded by an encoder.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the embodiments of the present disclosure. The computer readable media may include magnetic recording media, optical recording media and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary embodiments of the present disclosure have been described for illustrative purposes, those skilled in the art will appreciate that various modifications, additions and substitutions are possible, without departing from the essential characteristics of the disclosure. Therefore, exemplary embodiments of the present disclosure have not been described for limiting purposes. Accordingly, the scope of the disclosure is not to be limited by the above embodiments but by the claims and the equivalents thereof.

### INDUSTRIAL APPLICABILITY

As described above, the present disclosure is highly useful for application in the fields of video encoding and decoding since it can improve data compression and encoding performances by calculating the probability of encoding modes or decoding modes of a current block to be encoded or decoded and accordingly assigning a bin string or switching a preset sequence of encoding modes, and changing an indexing sequence of encoding modes or decoding modes or variable-length codes, adaptively to video characteristics to efficiently manage transmission bit.

### CROSS-REFERENCE TO RELATED APPLICATION

If applicable, this application claims priority under 35 U.S.C §119(a) of Patent Application No. 10-2010-0076790, filed on Aug. 10, 2010 in Korea, the entire content of which is incorporated herein by reference. In addition, this non-provisional application claims priority in countries, other than the U.S., with the same reason based on the Korean patent application, the entire content of which is hereby incorporated by reference.

1. (canceled)

2. A video encoding apparatus comprising:
a probability generation unit for calculating a probability of each encoding mode of blocks completely encoded before a current block;
a bit assignment unit for assigning and indexing a bin string according to the probability of said each encoding mode, which is calculated by the probability generation unit; and
a video encoding unit for encoding an encoding mode of the current block based on the bin string assigned by the bit assignment unit, when the current block is encoded.

3. The video encoding apparatus of claim 2, further comprising an exception processing unit for updating the bin string assigned by the bit assignment unit by transmitting additional bit of a video, a characteristic of which happens to change.

4. The video encoding apparatus of claim 2, wherein the probability generation unit calculates probabilities of skip modes of the blocks completely encoded before the current block, and a probability of each division mode.

5. The video encoding apparatus of claim 2, wherein the probability generation unit calculates the probability of each encoding mode of the blocks completely encoded before the current block in at least one unit of a frame, a sequence, and an encoding unit.

6. The video encoding apparatus of claim 2, wherein the bit assignment unit assigns the bin string, based on at least one of a Huffman code, an arithmetic code, and an exponential Golomb code.

7-8. (canceled)

9. A video encoding apparatus comprising:
a probability generation unit for calculating a probability of each encoding mode of blocks completely encoded before a current block;
a coding sequence switching unit for switching and indexing a preset sequence of encoding modes according to the probability of each encoding mode, which is calculated by the probability generation unit; and
a video encoding unit for video encoding unit for encoding an encoding mode of the current block based on a sequence switched by the coding sequence switching unit, when the current block is encoded.

10. The video encoding apparatus of claim 9, further comprising an exception processing unit for re-switching the sequence switched by the coding sequence switching unit according to a changing characteristic of a video.

11. The video encoding apparatus of claim 9, wherein the probability generation unit calculates probabilities of skip modes of the blocks completely encoded before the current block, and a probability of each division mode.

12. The video encoding apparatus of claim 9, wherein the probability generation unit calculates the probability of each encoding mode of the blocks completely encoded before the current block in at least one unit of a frame, a sequence, and an encoding unit.

13-14. (canceled)

15. A video decoding apparatus comprising:
a probability generation unit for calculating a probability of each decoding mode of blocks completely decoded before a current block;
a bit assignment unit for assigning and indexing a bin string according to the probability of each decoding mode, which is calculated by the probability generation unit; and
a video decoding unit for decoding a decoding mode of the current block based on the bin string assigned by the bit assignment unit, when the current block is decoded.

16. The video decoding apparatus of claim 15, further comprising an exception processing unit for updating the bin string assigned by the bit assignment unit by transmitting additional bit of a video, a characteristic of which happens to change.

17. The video decoding apparatus of claim 15, wherein the probability generation unit calculates probabilities of skip modes of the blocks completely decoded before the current block, and a probability of each division mode.

18. The video decoding apparatus of claim 15, wherein the probability generation unit calculates the probability of each decoding mode of the blocks completely decoded before the current block in at least one unit of a frame, a sequence, and an encoding unit.

19. (canceled)

20. A video decoding apparatus comprising:
a probability generation unit for calculating a probability of each decoding mode of blocks completely decoded before a current block;
a coding sequence switching unit for switching and indexing a preset sequence of decoding modes according to the probability of each decoding mode, which is calculated by the probability generation unit; and
a video decoding unit for indexing and decoding a decoding mode based on a sequence switched by the coding sequence switching unit, according to a decoding mode of the current block, when the current block is decoded.

21. The video decoding apparatus of claim 20, further comprising an exception processing unit for re-switching the sequence switched by the coding sequence switching unit according to a changing characteristic of a video.

22. The video the probability generation unit calculates probabilities of skip modes of the blocks completely decoded before the current block, and a probability of each division mode.

23. The video decoding apparatus of claim 20, wherein the probability generation unit calculates the probability of each decoding mode of the blocks completely decoded before the current block in at least one unit of a frame, a sequence, and an encoding unit.

24-37. (canceled)

38. A video decoding method comprising:
calculating a probability of each decoding mode of blocks completely decoded before a current block;
assigning and indexing a bin string according to a calculated probability of each decoding mode; and
decoding a decoding mode of the current block, based on an assigned bin string, when the current block is decoded.

39. The video decoding method of claim 38, further comprising updating the assigned bin string by transmitting additional bit of a video, a characteristic of which happens to change.

40. The video decoding method of claim 38, wherein the process of calculating the probability calculates probabilities of skip modes of the blocks completely decoded before the current block, and a probability of each division mode.

41. The video decoding method of claim 38, wherein the process of calculating the probability calculates the probability of each decoding mode of the blocks completely decoded before the current block in at least one unit of a frame, a sequence, and an encoding unit.

42. (canceled)

43. A video decoding method comprising:
calculating a probability of each decoding mode of blocks completely decoded before a current block;
switching and indexing a preset sequence of decoding modes according to a calculated probability of each decoding mode; and
decoding a decoding mode of the current block based on the sequence switched by a sequence switching process, when the current block is decoded.

44. The video decoding method of claim 43, further comprising re-switching the sequence switched by the sequence switching process, according to a changing characteristic of a video.

45. The video decoding method of claim 43, wherein the process of calculating the probability calculates probabilities of skip modes of the blocks completely decoded before the current block, and a probability of each division mode.

46. The video decoding method of claim 43, wherein the process of calculating the probability calculates the probability of each decoding mode of the blocks completely decoded before the current block in at least one unit of a frame, a sequence, and an encoding unit.

47. (canceled)
